(19) United States
(12) Patent Application Publication
(10) Pub. No.: US 2007/0188509 A1
(43) Pub. Date: Aug. 16, 2007

(54) Image displaying medium, image display device, and image displaying method

(75) Inventors: Kiyoshi Shigehiro, Kanagawa (JP); Yasufumi Suwabe, Kanagawa (JP); Yoshinori Machida, Kanagawa (JP); Yoshiro Yamaguchi, Kanagawa (JP); Takeshi Matsunaga, Kanagawa (JP); Atsushi Hirano, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/511,225

(22) Filed: Aug. 29, 2006

(30) Foreign Application Priority Data
Feb. 14, 2006 (JP) 2006-036877

(51) Int. Cl. G09G 5/00

(52) U.S. Cl. 345/581

(57) ABSTRACT

The present invention provides an image display medium comprising a pair of substrates at least one of which having translucency, the substrates being disposed opposite to each other with a gap, a dispersion medium which has translucency and is enclosed in a space between the pair of substrates; and plural kinds of particle groups which are movably dispersed in the dispersion medium, move according to an electric field formed, and have different colors and forces for separation from the substrates.

### BACKGROUND

1. Technical Field

The present invention relates to an image display medium, an image display device, and an image displaying method, and in particular relates to an image display medium, an image display device, and an image displaying method that display an image by the movement particles.

2. Related Art

Conventionally, display technologies such as Twisting Ball Display (rotational display by particles colored separately into two colors), or using electrophoresis, magnetophoresis, thermal rewritable medium, liquid crystal having memory function and the like have been proposed for a sheet-like image display medium which is repeatedly rewritable.

Among the above described display technologies, although thermally rewritable medium and liquid crystal having memory function are excellent in memory function for image, a color of its display surface cannot be made as white as white paper. Thus, it is difficult to confirm a distinction between image parts and non-image parts by means of visual observation in the case when a certain image is displayed, that is, there has been a problem of poor image quality. Other display technologies using electrophoresis or magnetophoresis are provided with memory function for image, and colored particles are dispersed in a white liquid. Thus, the display technologies using electrophoresis or magnetophoresis are excellent in white displaying. However, there has been a problem of poor image quality, since the white liquid enters between colored particles, black color forming image parts results in grayish.

Moreover, since white liquid is enclosed inside an image display medium, there is a possibility that the white liquid would leak outside the image display medium, if the image display medium is removed from an image display unit and handled roughly like paper. As another technology, a Twisting Ball Display has a memory function. Since inside an image display medium oil exists only in cavities around particles, but in a substantially solid state, it is comparatively easy to make the image display medium in the form of a sheet. However, even if each hemispherical surface of the particles has been coated in white and perfectly aligned at a display side, light entering between spheres of the particles is not reflected and is lost inside the display. Thus, in principle, a white display having a coverage of 100% cannot be achieved, and the color of the display results in slightly grayish appearance. Further, since a particle size is required to be smaller than a pixel size in order to obtain a high resolution, particles having different colors coated on must be made smaller, requiring a manufacturing technique of a high degree of precision.

A display technology, in which a conductive colored toner and white particles are contained in space between opposing electrode substrates, and electric charges are injected through a charge transport layer disposed on the inside surface of the electrode of a non-display substrate to the conductive colored toner, and an electric field between the electrode substrates causes charge-injected conductive colored toner to move toward a display substrate located facing the non-display substrate, and the conductive colored toner sticks to the inside of the display substrate, and contrast between the conductive colored toner and the white particles enables display of an image, was proposed as a display technology using a toner that solves such problems as mentioned above. The display technology is excellent in that the whole image display medium is made of solid matters and that display of white and black (color) can be completely switched in principle.

However, the above-described display technologies are in principle for achieving good two-color contrast, thus multi-color display of two or more colors requires separately driving pixels which are divided into segments such as CMY and RGB. Such dividing of pixels could reduce the display resolution to one third, even when the same number of pixels is used.

### SUMMARY

The present invention has been made in view of the above circumstances and provides an image display medium, an image display device, and an image displaying method.

According to an aspect of the invention, there is provided an image display medium comprising: a pair of substrates at least one of which having translucency, the substrates being disposed opposite to each other with a gap therebetween; a dispersion medium which has translucency and is enclosed between the pair of substrates; and plural kinds of particle groups which are movably dispersed in the dispersion medium, move according to an electric field, and different kinds have different colors and different forces for separation from the substrates.

### BRIEF DESCRIPTION OF THE DRAWINGS

Embodiments of the present invention will be described in detail based on the following figures, wherein:

FIG. 1 is a schematic block diagram of the image display device according to the present exemplary embodiment;

FIG. 2 is a diagram schematically showing the relationship between the potential difference (electric field intensity) per unit distance and the amount of particle movement;

FIG. 3 is an explanatory drawing schematically showing the relationship between the embodiments of the formation of an electric field in the image display medium and the embodiments of particle movement.

### DETAILED DESCRIPTION

The present invention is further described below.

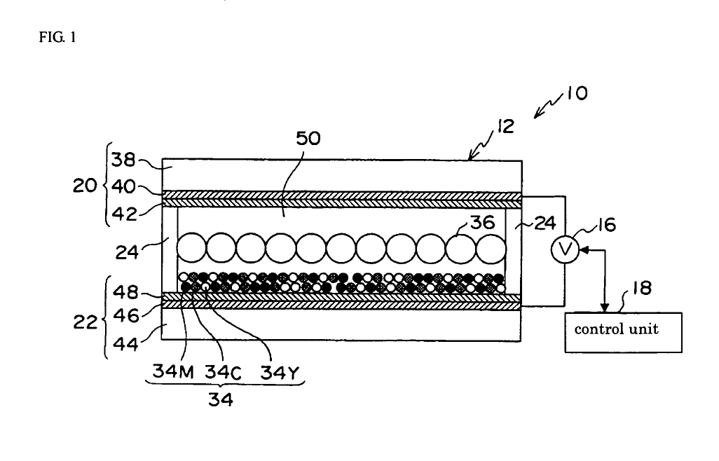

As shown in FIG. 1, an image display medium 12 according to the exemplary embodiment of the invention comprises a display substrate 20 used as the image display surface, a rear substrate 22 disposed opposite to the display substrate 20 with a gap, a gap member 24 for maintaining a predetermined gap between the substrates and dividing the space between the display substrate 20 and the rear substrate 22 into plural cells, and particle groups 34 enclosed in the cells.

The above-described cell refers to the region enclosed by the display substrate 20, the rear substrate 22, and the gap member 24. A dispersion medium 50 is enclosed in the cell. The particle groups 34 (described in detail later) are dispersed in the dispersion medium 50, and move between the display substrate 20 and the rear substrate 22 according to the intensity of an electric field formed in the cell.

Moreover, the image display medium 12 can be configured to allow the color display of each pixel by providing the gap member 24 corresponding to each pixel in an image displayed on the image display medium 12, and forming a cell corresponding to each pixel or several pixels.

In the display substrate 20, a supporting substrate 38, a surface electrode 40, and a surface layer 42 are laminated in this order. In the rear substrate 22, a supporting substrate 44, a rear electrode 46, and a surface layer 48 are laminated in this order.

Examples of the supporting substrate 38 and the supporting substrate 44 include glass and plastic such as polycarbonate resin, acrylic resin, polyimide resin, polyester resin, epoxy resin, and polyether sulfone resin.

Examples of the rear electrode 46 and the surface electrode 40 include oxides of indium, tin, cadmium, and antimony, complex oxides such as ITO, metals such as gold, silver, copper, and nickel, and organic conductive materials such as polypyrrole and polythiophene. These materials can be used as a single layer film, a mixture film, or a composite film, and can be formed by vapor deposition, sputtering, application or other appropriate methods. The thickness of a film formed by vapor deposition or sputtering is usually 100 to 2000 angstrom. The rear electrode 46 and the surface electrode 40 can be formed into a desired pattern, for example, matrix form or stripe form which allows passive matrix driving, by a conventionally known methods such as etching for conventional liquid crystal display elements or printed boards.

The surface electrode 40 may be embedded in the supporting substrate 38. In the same manner, the rear electrode 46 may be embedded in the supporting substrate 44. In this case, because the material of the supporting substrate 38 and the supporting substrate 44 may affect the charging characteristics and flowability of the each particles of the particle groups 34, it is properly selected in consideration of the composition and other properties of the particles of the particle groups 34.

The rear electrode 46 and the surface electrode 40 may be separated from the display substrate 20 and the rear substrate 22, respectively, and disposed outside the image display medium 12. In this case, the image display medium 12 is disposed between the rear electrode 46 and the surface electrode 40, thus the distance between the rear electrode 46 and the surface electrode 40 increases and the electric field intensity decreases. Accordingly, in order to obtain a desired intensity of electric field, it is necessary to decrease the thickness of the supporting substrate 38 and the supporting substrate 44 substrate or the distance between the supporting substrate 38 and the supporting substrate 44 in the display medium 12.

In the above-described case, the electrodes (surface electrode 40 and rear electrode 46) are provided on both the display substrate 20 and the rear substrate 22, but an electrode may be provided on either of which to allow active matrix driving.

In order to allow active matrix driving, the supporting substrate 38 and the supporting substrate 44 may have a TFT (thin-film transistor) for each pixel. TFT is preferably formed not on the display substrate but on the rear substrate 22 from the viewpoint of easiness of lamination of wiring and mounting of components.

When the image display medium 12 is driven by a passive matrix system, the configuration of the image display device 10 comprising the image display medium 12, which will be described later, can be simplified. On the other hand, when the image display medium 12 is driven by an active matrix system using TFT, the display speed is faster than that achieved by passive matrix driving.

When the surface electrode 40 and the rear electrode 46 are formed on the supporting substrate 38 and the supporting substrate 44, respectively, it is preferred, as necessary, to form the surface layer 42 and/or the surface layer 48 as a dielectric film on the surface electrode 40 and the rear electrode 46, respectively, to prevent the breakage of the surface electrode 40 and the rear electrode 46 and the leakage between the electrodes which can cause the coagulation of the particles of the particle groups 34.

Examples of the material of the surface layer 42 and/or the surface layer 48 include polycarbonate, polyester, polystyrene, polyimide, epoxy, polyisocyanate, polyamide, polyvinyl alcohol, polybutadiene, polymethyl methacrylate, copolymerized nylon, ultraviolet curing acrylic resin, and fluorocarbon resins and so on.

In addition to the above insulating materials, insulating materials enclosing a charge transporting substance can be used. When a charge transporting substance is enclosed, the charging properties of the particles is improved by the injection of an electric charge into the particles, and an excessive charge of the particles can be leaked to stabilize the charge of the particles.

Examples of the charge transporting substance include hole transporting substances such as hydrazone compounds, stilbene compounds, pyrazoline compounds, and aryl amine compounds, electron transporting substances such as fluorenone compounds, diphenoquinone derivatives, pyran compounds, and zinc oxide, and self-supporting resins having charge transporting properties.

Specific examples thereof include polyvinyl carbazole, and polycarbonate obtained by the polymerization of a specific dihydroxy aryl amine and bischloroformate as described in U.S. Pat. No. 4,806,443. Because the dielectric film may affect the charging characteristics and flowability of the particles, it is properly selected in consideration of the composition and other properties of the particles. The display substrate, which is one of the pair of substrates, is preferably made of a transparent material selected from the above materials because it must transmit light.

The gap member 24 for maintaining a gap between the display substrate 20 and the rear substrate 22 is formed in such a manner not to impair the transparency of the display substrate 20, and may be formed with a thermoplastic resin, a thermosetting resin, an electron radiation curing resin, a light curing resin, a rubber, a metal, or the like.

The gap member 24 is in cell form or particle form. Examples of the cell-form gap member include nets. Nets are readily available and have a relatively uniform thickness, thus are useful for producing the image display medium 12 at a low cost. Nets are not suitable for displaying a fine image, but are preferably used in a large image display device which does not require high resolution. Examples of the cell form spacer include a sheet perforated in matrix form by etching, laser processing or the like. Such a sheet is easier to control the thickness, hole shape, hole size and the like than a net. Therefore, a sheet used in an image display medium is effective for displaying a fine image and improving contrast.

The gap member 24 may be integrated with either the display substrate 20 or the rear substrate 22. The supporting substrate 38, the supporting substrate 44, and the gap member 24 may be subjected to etching, laser processing, pressing with a premold die, printing or other treatments to form cell patterns of a desirable size.

In this case, the gap member 24 may be provided on either the display substrate 20 or the rear substrate 22, or both of them.

The gap member 24 may be colored or colorless, but is preferably colorless and transparent not to adversely affect the image which is displayed on the image display medium 12. In that case, for example, transparent resins such as polystyrene, polyester, and acryl resins or the like can be used as the member.

The gap member 24 in particle form is preferably transparent, and examples thereof include particles of transparent resins such as polystyrene, polyester and acryl resins, and glass particles.

In the dispersion medium 50 used in the image display medium 12 of the invention, plural kinds of particle groups 34 which have different colors and different forces for separation from the display substrate 20 and the rear substrate 22 (hereinafter may be referred to as force for separation) are dispersed.

The force for separation is calculated by subtracting the force to bind the particle groups 34 on the display substrate 20 or the rear substrate 22 (hereinafter referred to as binding force) from the electrostatic force of the particle groups 34, and is the force to detach the particles from the display substrate 20 and the rear substrate 22. The binding force is, for example, a magnetic force, a flow resistance of particles due to the weak interparticle network, and van der Waals forces between particles and the display substrate 20 or the rear substrate 22.

More specifically, the force for separation of the particle groups 34 from the display substrate 20 and the rear substrate 22 represents the difficulty in the detachment of the particles of the particle groups 34 from the display substrate 20 and the rear substrate 22. The force for separation of the particle groups 34 from the display substrate 20 and the rear substrate 22 represents, in consideration that the particle groups 34 move according to the electric field formed between the substrates (between the display substrate 20 and the rear substrate 22), the difference in the electric field intensity at which the particles initiate moving in the dispersion medium 50.

Thus, the particles of the particle groups 34 initiates moving from either the display substrate 20 or the rear substrate 22 for the other substrate at different intensities of the electric field. More specifically, the particles of the plurality of kinds of particle groups 34 dispersed in the dispersion medium 50 have different threshold characteristics for the electric field intensity.

Examples of the particles of the plurality kinds of particle groups 34, which have different thresholds for the electric field intensity to initiate moving, include glass beads, particles of insulating metal oxides such as alumina and titanium oxide, thermoplastic or thermosetting resin particles, these resin particles having colorants attached to the surface, thermoplastic or thermosetting resin particles containing insulating colorants, and metal colloid particles having the color atrength due to the surface plasmon resonance.

Examples of the thermoplastic resin used to produce the particles include homopolymers or copolymers of styrenes such as styrene and chlorostyrene, monoolefins such as ethylene, propylene, butylene, and isoprene, vinyl esters such as vinyl acetate, vinyl propionate, vinyl benzoate, and vinyl butyrate, α-methylene aliphatic monocarboxylic acid esters such as methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate, vinyl ethers such as vinyl methyl ether, vinyl ethyl ether, and vinyl butyl ether, and vinyl ketones such as vinyl methyl ketone, vinyl hexyl ketone, and vinyl isopropenyl ketone.

Examples of the thermosetting resin used to produce the particles include crosslinked copolymers mainly composed of divinyl benzene, crosslinked resins such as crosslinked polymethyl methacrylate, phenolic resin, urea resin, melamine resin, polyester resin, and silicone resin. Examples of the typical binding resin include polystyrene, styrene-alkyl acrylate copolymer, styrene-alkyl methacrylate copolymer, styrene-acrylonitrile copolymer, styrene-butadiene copolymer, styrene-maleic anhydride copolymer, polyethylene, polypropylene, polyester, polyurethane, epoxy resin, silicone resin, polyamide, denatured rosin, and paraffin wax.

As the colorant, organic or inorganic pigments, and oil-soluble dyes can be used. Examples thereof include known colorants such as magnetic powder such as magnetite and ferrite, carbon black, titanium oxide, magnesium oxide, zinc oxide, phthalocyanine copper-based cyan coloring materials, azo-based yellow coloring materials, azo-based magenta coloring materials, quinacridone-based magenta coloring materials, red coloring materials, green coloring materials, and blue coloring materials. Specific examples thereof include aniline blue, chalcoil blue, chromium yellow, ultramarine blue, Du Pont oil red, quinoline yellow, methylene blue chloride, phthalocyanine blue, malachite green oxalate, lamp black, rose bengal, C.I. pigment red 48:1, C.I. pigment red 122, C.I. pigment red 57:1, C.I. pigment yellow 97, C.I. pigment blue 15:1, and C.I. pigment blue 15:3.

Moreover, air-contained porous sponge-like particles and hollow particles can be used as white particles.

Charge controlling agents may be added to the resin particles as necessary. As the charge controlling agent, known agents used for electrophotographic toner materials can be used, and examples thereof include cetylpyridyl chloride, quaternary ammonium salts such as trade names: BONTRON P-51, BONTRON P-53, BONTRON E-84, BONTRON E-81 (manufactured by Orient Chemical Industries, Ltd.), salicylic acid-based metal complexes, phenol-based condensates, tetraphenyl-based compounds, metal oxide particles, and metal oxide particles surface-treated with various coupling agents.

Magnetic materials may be added to the inside or surface of the particles as necessary. As the magnetic material, organic and inorganic magnetic materials, which are color coated as appropriate, are used. Moreover, transparent magnetic materials, particularly transparent organic magnetic materials are more preferred because they do not inhibit the color forming of coloring pigments, and have lower specific gravity than inorganic magnetic materials.

As the colored magnetic powder, for example, small diameter colored magnetic powder as described in Japanese Patent Application Laid-Open (JP-A) No. 2003-131420 can be used. A particle comprising a magnetic particle as core and a colored layer laminated on the surface of the magnetic particle is used. The colored layer may be formed by impermeably coloring the magnetic powder with a pigment or the like, and, for example, a light-interference thin film is preferably used. The light-interference thin film is a thin film of an achromatic color material such as SiO₂ and TiO₂ having a thickness equivalent to light wavelength, and selectively reflects a specific wavelength of light by the light interference within the thin film.

An external additive can be added to the surface of the particles as necessary. The color of external additive is preferably transparent so as not to affect the particle color.

Examples of the external additive include inorganic particles of metal oxides such as silicon oxide (silica), titanium oxide, and alumina. In order to adjust the charging properties, flowability, environment-dependency of fine particles, these can be surface-treated by a coupling agent or silicone oil.

Examples of the coupling agent include those having positive charging properties, such as aminosilane-based coupling agents, aminotitanium-based coupling agents, and nitril-based coupling agents, and those having negative charging properties, such as nitrogen-free (composed of atoms other than nitrogen) silane-based coupling agents, titanium-based coupling agents, epoxy silane coupling agents, and acrylsilane coupling agents. Similarly, examples of the silicone oil include those having positive electrification nature, such as amino-denatured silicone oil, and those having negative charging properties, such as dimethyl silicone oil, alkyl-denatured silicone oils, α-methyl sulfone-denatured silicone oils, methylphenyl silicone oils, chlorphenyl silicone oils, and fluorine-denatured silicone oils. These are selected depending on a desired resistance of the external additive.

Among these external additives, well-known hydrophobic silica and hydrophobic titanium oxide are preferred, and titanium compounds as described in JP-A No. 10-3177, which are obtained by the reaction between TiO(OH)₂ and a silane compound such as a silane coupling agent, are particularly preferred. As the silane compound, any one of chlorosilane, alkoxy silane, silazane, special silylating agents can be used. The titanium compounds are produced by reacting TiO(OH)₂ prepared by wet process with a silane compound or silicone oil, and drying. As the compounds are not passed through a sintering process at several hundred degrees, Ti molecules do not form a strong bond between them and cause no aggregation. Accordingly, the obtained particles are nearly primary particles. Moreover, as TiO(OH)₂ is directly reacted with a silane compound or silicone oil, the loading of the silane compound or silicone oil can be adjusted to control the charging characteristics, and a significantly higher charging ability than that of conventional titanium oxide can be imparted.

The primary particle of the external additive is generally 5 to 100 nM, preferably 10 to 50 nM, but not limited thereto.

The mixing ration between the external additive and the particles is appropriately adjusted in consideration of the particle size of the particles and the external additive. If the loading of the external additive is too much, a portion of the external additive is liberated from the particle surface and adheres to the surface of other particles, which will result in the failure to achieve desired charging characteristics. The loading of the external additive is usually 0.01 to 3 parts by weight, more preferably 0.05 to 1 parts by weight with reference to 100 parts by weight of the particles.

The external additive may be added to any one kind of the plurality of kinds of particles, or plural or all kinds of the particles. When the external additive is added to the surface of all the particles, it is preferred to strongly fix the external additive to the particle surface by embedding the external additive in the particle surface by an impact force, or by heating the particle surface. Such treatments prevent the liberation of the external additive from the particles and strong aggregation of the external additive having opposite polarity to form aggregates of the external additive which is difficult to dissociate by electric field, which in turn prevents the deterioration of image quality.

As the method to prepare the particles groups, any conventionally known methods may be used. For example, a method as described in JP-A No. 7-325434 can be used, wherein a resin, a pigment, and a charge controlling agent is weighed in a predetermined mixing ratio, and the pigment is added to and mixed the heated and melted resin, and the mixture is dispersed. The dispersion is cooled and ground into particles in a mill such as a jet mill, a hammer mill, and a turbo mill, and then the obtained particles are dispersed in a dispersion medium. In an alternative method, particles containing a charge controlling agent are prepared by a polymerization method such as suspension polymerization, emulsion polymerization, and dispersion polymerization, or other method such as coacervation, melt dispersion, and emulsion aggregation, and dispersed in a dispersion medium to obtain a particle dispersion liquid. Another method uses an appropriate device which is capable of dispersing and mixing a resin, a colorant, a charge controlling agent and materials of the dispersion medium at a temperature at which the resin is plasticizable, the dispersion medium does not boil, and lower than the decomposition point of a charge controlling agent and/or a colorant. Specifically, a pigment, a resin, and a charge controlling agent is mixed in a shooting star type mixer or a kneader, and heated to melt in a dispersion medium. The melt mixture is cooled with stirring, coagulated, and deposited to obtain particles utilizing the temperature dependency of the solvent solubility of the resin.

Moreover, there is another method wherein the above-described raw materials are put in an appropriate vessel equipped with a granular media for dispersion and mixing, for example, an attritor or a heated vibration mill such as a heated ball mill, and dispersed and mixed in the vessel at a temperature preferably in a range of, for example, 80 to 160° C. As the granular media, steels such as stainless steel and carbon steel, and alumina, zirconia, and silica are preferably used. For preparing the particles by the method, thoroughly mobilized raw materials are dispersed in the vessel with a granular media, and the dispersion medium is cooled to precipitate the resin containing the colorant from the dispersion medium. The granular media generates a shearing motion and/or an impact motion by keeping moving during and even after cooling to decrease the particle size.

As the particles of the particle groups 34 used in the image display medium 12 of the invention, metal colloid particles having the color strength due to the plasmon resonance may be used as the particles exhibiting different color forming properties in a dispersed state.

The metal of the metal colloid particles may be precious metal, copper or the like (hereinafter collectively referred to as “metal”). The precious metal is not particularly limited, and examples thereof include gold, silver, copper, ruthenium, rhodium, palladium, osmium, iridium, and platinum. Among these metals, gold, silver, copper, and platinum are preferred.

The metal colloid particles are prepared by chemical methods wherein metal ions are reduced to metal atoms or metal clusters, then to nanoparticles, or physical method wherein a bulk metal is evaporated in an inert gas, and atomized metal is trapped with a cold trap or the like, or a metal is vacuum-deposited on a polymer thin film to form a metal thin film, and then the film is heated to break for dispersing the metal particles in a solid phase polymer. The chemical methods require no special apparatus and are advantageous for preparing the metal colloid particle of the invention. Examples thereof will be described later, but the methods are not limited thereto.

The metal colloid particles are formed from the compound of the above metals. The metal compound is not particularly limited as long as it contains the above-described metal, and examples thereof include chlorauric acid, silver nitrate, silver acetate, silver perchlorate, platinic chloride, platinum potassium, copper chloride (II), copper acetate (II), and copper sulfate (II).

The metal colloid particles can be obtained as a dispersion liquid of metal colloid particles prepared by dissolving the metal compound in a solvent, reducing the compound into a metal, and protecting the metal with a dispersant. Alternatively, the metal colloid particles also can be obtained in the form of solid sol by removing the solvent of the dispersion liquid. The metal colloid particles may take either forms.

When the metal compound is dissolved, a polymer pigment dispersant, which will be described later, may be used. By using the polymer pigment dispersant, stable metal colloid particles protected by the dispersant are obtained. In this case, the concentration of the dispersant adsorbed to the surface of the metal colloid particles can be controlled by using a polymer pigment dispersant of a desirable kind under desirable conditions (e.g., concentration and stirring time). More specifically, the amount of the polymer pigment dispersant adsorbed to the surface of the metal colloid particles can be increased by increasing the concentration or stirring of the polymer pigment dispersant. These treatments allow to control the mobility of the metal colloid particles.

When the metal colloid particles in the invention are used, they may be used as a dispersion liquid of the metal colloid particles obtained as described above, or as a solid sol obtained by removing the solvent and redispersing in other solvent. The metal colloid particles are not particularly limited in the invention.

When the metal colloid particles are used as a dispersion liquid, the solvent to prepare the liquid is preferably an insulating liquid which will be described later. When the solid sol is used after redispersion, the solvent to prepare the solid sol may be any solvent, and the solvent is not particularly limited. The solvent used for the redispersion is preferably an insulating liquid which will be described later.

The metal colloid particles can form various colors according to the kind, shape, volume average primary particle size of the metal. Accordingly, by using the particles of appropriate metal, shape, and volume average primary particle size, various color phases including the RGB color forming can be obtained, which achieves the color display medium of the image display medium 12 of the invention. Moreover, by controlling the shape and the particle size of the metal and resulting metal colloid particles, a RGB-type full color display medium is obtained.

The volume average primary particle size of the metal colloid particles for forming each color of the RGB type, or R, G, and B, is not particularly specified because the color forming also depends on the preparation conditions, shape, particle size or the like of the metal and particles. However, for example, for the case of gold colloid particles, R, G, and B colors are sequentially developed with the increase in the volume average primary particle size.

As the method to measure the volume average primary particle size in the invention, a laser diffraction scattering method is used, in which the particle groups is irradiated with laser beam, and the generated diffraction and the intensity distribution pattern of scattered light are used to measure the average particle size.

The content (% by mass) of the particle groups 34 with reference to the total weight in the cell is not particularly limited as long as it is on a level which can obtain a desired color phase. It is effective for the image display medium 12 to adjust the content according to the cell thickness. More specifically, the content may be decreased for a thick cell, or may be increased for a thin cell to obtain a desired color phase. The content is usually 0.01 to 50% by mass.

As the method to prepare the metal colloid particles, for example, a typical preparation method as described in a reference, “Kinzoku Nanoryushino Gosei, Chosei, Control Gijutsuto Oyotenkai (Synthesis, Preparation, and Control Technique of Metal Nanoparticles and Development of Applications)” (Technical Information Institute Co., Ltd., 2004) can be used. An example of the preparation is described below, but the method is not limited thereto.

In the image display medium 12 of the invention, insulating particles 36 are enclosed in each cell. The insulating particles 36 are insulating particles having a color different from that of the particle groups 34 enclosed in the same cell. The particles of the particle groups 34 are each disposed with a passable gap in the direction generally normal to the opposing direction of the rear substrate 22 and the display substrate 20. Gaps are provided between the insulating particle 36 and the rear substrate 22, and between the display substrate 20 and the insulating particle 36, which allow to laminate plural layers of the particles of the particle groups 34 enclosed in the same sell in the opposing direction of the rear substrate 22 and the display substrate 20.

More specifically, the particles of the particle groups 34 can move from the rear substrate 22 to the display substrate 20, or from the display substrate 20 to the rear substrate 22 through the gap between the insulating particles 36. The color of the insulating particle 36 is preferably, for example, white or black as a background color.

Examples of the insulating particles 36 include spherical particles of benzoguanamine-formaldehyde condensate, spherical particles of benzoguanamine-melamine-formaldehyde condensate, spherical particles of melamine-formaldehyde condensate (trade name: Epostar, manufactured by Nippon Shokubai Co., Ltd.), spherical fine particles of crosslinked polymethyl methacrylate containing titanium oxide (trade name: MBX-White, manufactured by Sekisui Plastics Co., Ltd.), spherical fine particles of crosslinked polymethyl methacrylate (trade name: Chemisnow MX, manufactured by Sohken Kagaku), fine particles of polytetrafluoroethylene (trade name: Lubron L, manufactured by Daikin Industries, Ltd., trade name: SST-2, manufactured by Shamrock Technologies Inc.); fine particles of carbon fluoride (trade name: CF-100, manufactured by Nippon Carbon Co., Ltd., trade names: CFGL, CFGM, manufactured by Daikin Kogyo); silicone resin fine particles (trade name: Tosspearl, manufactured by Toshiba Silicone K.K.); fine particles of polyester containing titanium oxide (trade name: Biryushea PL 1000 White T, manufactured by Nippon Paint Co., Ltd.); polyester-acrylic fine particles containing titanium oxide (trade name: Konac No. 1800 White, manufactured by NOF CORPORATION); spherical fine particles of silica (trade name: Hipresica, manufactured by UBE-NITTO KASEI Co., Ltd.) and the like.

The insulating particles are not limited to the above particles, but may be those obtained by dispersing a white pigment such as titanium oxide in a resin, grinding, and classifying into a desired particle size.

The insulating particles 36 have a volume average primary particle size of ⅕ to 1/50 the length of the opposing direction of the display substrate 20 and the rear substrate 22 so as to be provided between the display substrate 20 and the rear substrate 22 as described above, and the content of the insulating particles 36 must be 1 to 50% by volume with reference to the volume of the cell.

The dispersion medium 50 is preferably an insulating liquid.

As the insulating liquid, specifically, hexane, cyclohexane, toluene, xylene, decane, hexadecane, kerosene, paraffin, isoparaffin, silicone oil, dichloroethylene, trichloroethylene, perchloroethylene, high purity kerosene, ethylene glycol, alcohols, ethers, esters, dimethylformamide, dimethyl acetamide, dimethyl sulfoxide, N-methylpyrrolidone, 2-pyrrolidone, N-methylformamide, acetonitrile, tetrahydrofuran, propylene carbonate, ethylene carbonate, benzine, diisopropyl naphthalene, olive oil, isopropanol, trichlorotrifluoroethane, tetra chloroethane, dibromotetrafluoroethane, and mixtures thereof can be appropriately used.

Water (or pure water) can be appropriately used as a dispersion medium by removing impurities to achieve the later-described volume resistance. The volume resistance is preferably 10³ Ωcm or more, more preferably 10⁷ Ωcm to 10¹⁹ Ωcm, further preferably 10¹⁰ Ωcm to 10¹⁹ Ωcm. By achieving such volume resistance, the generation of bubbles due to the electrode reaction of the liquid is more effectively reduced, and the electrophoresis characteristics of the particle are not impaired at every conduction, which imparts excellent repeating stability to the particles.

As necessary, an acid, an alkali, a salt, a dispersion stabilizer, a stabilizer for preventing oxidation or absorbing ultraviolet light, an antibacterial agent, a preservative or the like may be added to the insulating liquid, and the content is preferably in the range which results in the specific volume resistance value as described above.

Moreover, an anion surfactant, a cation surfactant, an amphoteric surfactant, a nonionic surfactant, a fluorine-based surfactant, a silicone-based surfactant, a metallic soap, an alkyl phosphoric acid ester, a succinic acid imide or the like may be added to the insulating liquid as a charge controlling agent.

Examples thereof include ionic or nonionic surfactants, block or graft copolymers composed of lipophilic and hydrophilic moieties, compounds having a polymer chain backbone, such as cyclic, star-shaped, or dendritic polymers (dendrimers), and compounds selected from metal complexes of salicylic acid, metal complexes of catechol, metal-containing bisazo dyes, tetraphenyl borate derivatives or the like.

Specific examples of the surfactant include nonionic surfactants such as polyoxyethylene nonylphenyl ether, polyoxyethylene octylphenyl ether, polyoxyethylene dodecylphenyl ether, polyoxyethylene alkyl ether, polyoxyethylene fatty acid ester, sorbitan fatty acid ester, polyoxyethylene sorbitan fatty acid ester, and fatty acid alkylol amide; anion surfactants such as alkylbenzene sulfonate, alkylphenyl sulfonate, alkylnaphthalene sulfonate, higher fatty acid salts, sulfate ester salts of higher fatty acid esters, and sulfonic acids of higher fatty acid esters;and cationic surfactants such as primary to tertiary amine salts, and quaternary ammonium salts. The content of such charge controlling agent is preferably 0.01% by weight or more and 20% by weight or less, most preferably 0.05 to 10% by weight with reference to the particle solid content. If the content is less than 0.01% by weight, satisfactory charge control effect cannot be achieved, and if exceeds 20% by weight, the conductivity of the developer is excessively increased to impair the usability of the developer.

The particle groups 34 enclosed in the image display medium 12 of the invention is also preferably dispersed as a dispersion medium 50 in the polymer resin in the image display medium 12. The polymer resin is preferably a polymer gel, a network polymer or the like.

Examples of the polymer resin include polymer gel derived from natural polymer, such as agarose, agaropectin, amylose, sodium alginate, propyleneglycol alginate ester, isolichenan, insulin, ethyl cellulose, ethylhydroxyethyl cellulose, curdlan, casein, carrageenan, carboxymethyl cellulose, carboxymethyl starch, callose, agar, chitin, chitosan, silk fibroin, Cyamoposis Gum, pyrus cydonia seed, crown gall polysaccharide, glycogen, glucomannan, keratan sulfate, keratin protein, collagen, cellulose acetate, gellan gum, schizophyllan, gelatin, ivory palm mannan, tunicin, dextran, dermatan sulfate, starch, tragacanth gum, nigeran, hyaluronic acid, hydroxyethyl cellulose, hydroxypropyl cellulose, pustulan, funoran, decomposed xyloglucan, pectin, porphyran, methyl cellulose, methyl starch, laminaran, lichenan, lenthinan, and locust bean gum; and synthetic polymer including nearly all kinds of polymer gels.

Another examples include polymers containing functional groups such as alcohol, ketone, ether, ester, and amide in the repeating units, such as, polyvinyl alcohol, poly(meth)acrylamide and derivatives thereof, polyvinyl pyrrolidone, polyethylene oxide and copolymers containing these polymers.

Among them, gelatin, polyvinyl alcohol, and poly(meth)acrylamide are preferably used from the viewpoints of production stability and electrophoresis characteristics.

These polymer resins are preferably used as a dispersion medium 50 together with the insulating liquid.

The size of the cell in the image display medium 12 of the invention is usually 10 μm to 1 mm. The cell size is in a close relationship with the resolution of the image display medium 12, and the smaller the cell, the higher the resolution of the display medium.

For fixing the display substrate 20 and the rear substrate 22, fixing units such as a combination of bolts and nuts, a clamp, a clip, and a frame for fixing substrate can be used. Moreover, fixing media such as adhesion, heat fusion, ultrasonic bonding can be used.

The image display medium 12 can be used for bulletin boards, circulars, electronic whiteboards, advertisements, signboards, blinking markers, electronic paper, electronic newspaper, and electronic books on which images can be stored and rewritten, and document sheets which can be shared between copiers and printers.

The image display medium 12 displays different colors by varying the electric field intensity (potential difference (V/m) per unit distance) between the display substrate 20 and the rear substrate 22.

The image display medium 12 of the invention can display colors corresponding to each pixel of the image data in each cell corresponding to each pixel of the image display medium 12 by moving according to the electric field formed between the display substrate 20 and the rear substrate 22.

As described above, the particle groups 34 have different forces for separation from the display substrate 20 and the rear substrate 22, and different threshold characteristics for the electric field intensity.

The “electric field intensity” refers to the potential difference (V/m) per unit distance. More specifically, the difference in the threshold characteristics for an electric field intensity means the difference in the electric field intensity required for the color particles of the particle groups 34 to move from one of the display substrate 20 or the rear substrate 22 to the other substrate.

For example, as shown in FIG. 1, when a magenta particle group 34M of magenta color, a cyan particle group 34C of cyan color, and a yellow particle group 34Y of yellow color are enclosed as the particle groups 34 in the same cell of the image display medium 12, the threshold for the electric field intensity at which the particles of the magenta particle group 34M, the cyan particle group 34C, and the yellow particle group 34Y initiate moving varies with the kind of the particle groups (magenta particle group 34M, cyan particle group 34C, and yellow particle group 34Y).

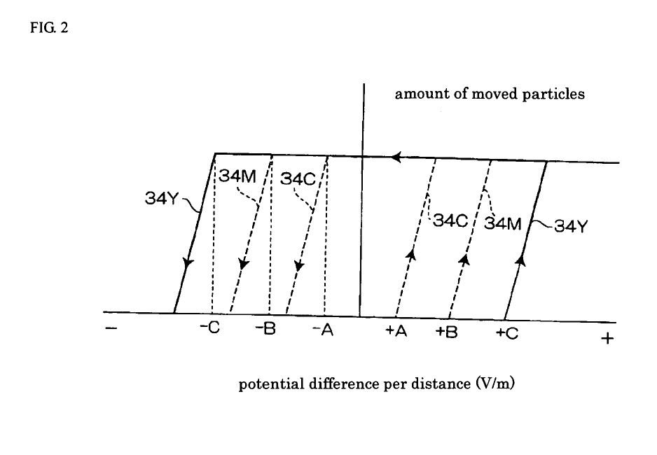

More specifically, in plural kinds of particle groups 34 (yellow particle group 34Y, magenta particle group 34M, and cyan particle group 34C) used in the image display medium 12 of the invention, the threshold of the electric field intensity decreases in the order: the yellow particle group 34Y; the magenta particle group 34M; the cyan particle group 34C. Therefore, as shown in FIG. 2, the cyan particle group 34C of the plural particle groups initiates moving from one of the substrate to the other substrate when a potential difference of +AV per unit distance is generated between the display substrate 20 and the rear substrate 22. Moreover, when a potential difference of +BV is generated as a potential difference larger than +A, the magenta particle group 34M initiates moving from one substrate to the other substrate. Furthermore, when a potential difference of +CV is generated as a potential difference larger than +B, the yellow particle group 34Y initiates moving from one substrate to the other substrate.

In the same manner, when a potential difference of −AV per unit distance is generated between the display substrate 20 and the rear substrate 22, the cyan particle group 34C, of the magenta particle group 34M, the cyan particle group 34C, and the yellow particle group 34Y, initiates moving from the other substrate to the original substrate. Moreover, when a potential difference of −BV is generated as a potential difference larger than −A, the magenta particle group 34M initiates moving from the other substrate to the original substrate. Furthermore, when a potential difference of −CV is generated as a potential difference larger than −B, the yellow particle group 34Y moves from the other substrate to the original substrate.

As described above, the plurality of kinds of particle groups 34 dispersed in the dispersion medium 50 of the image display medium 12 of the invention initiate moving from one of the opposing substrates to the other substrate at different thresholds for the electric field intensity.

The next section describes the method to vary the threshold for the electric field intensity to initiate moving among the colors of the particle groups 34.

In the first place, the force which serves as a binding force is described. When the plurality of kinds of particle groups 34 are attached to either the display substrate 20 or the rear substrate 22, an adhesion force to attach the substrate is working between the particles of the particle groups 34 and the display substrate 20 or the rear substrate 22. The adhesion force is a van der Waals force specific to a substance which is generated by physical contact. The force depends on the contact area between the particles and the substrate, and the distance between the particles and the substrate. The force becomes larger as the contact area increases and the distance decreases. The contact area and the distance depend on the particle size (volume average primary particle size) and the shape factor of the particles. The van der Waals force also depends on the material of the particles and the substrate surface.

When the particles have an electric charge, an image force is generated between the display substrate 20 or the rear substrate 22 to which the particles are attached, but the image force is said to be smaller than other forces.

When the particles have magnetization, a magnetic force is generated between the particles in the vicinity of the display substrate 20 or, the rear substrate 22 and the display substrate 20 or the rear substrate 22. In this case, a magnet is provided on the display substrate 20 or the rear substrate 22 to generate a magnetic gradient on the basis of the magnetic flux from the magnet in the vicinity of the display substrate 20 or the rear substrate 22, by which a magnetic force is exerted on the particles in the vicinity of the display substrate 20 or the rear substrate 22.

Moreover, as the plurality of kinds of particle groups 34 are dispersed in the dispersion medium 50, when an electric field is applied to the space between the display substrate 20 and the rear substrate 22 to initiate moving the particles, a resistance is generated at the interface between the surface of the particles and the dispersion medium 50. The resistance is considered to be generated due to the interparticle loose network formed between the particles accumulated on and in the vicinity of the substrate surface. The resistance becomes largest when the particles initiate moving, and gradually decreases with the movement. Hereinafter the maximum value of the resistance at the interface between the dispersion medium 50 and the particles of the particle groups 34 (the resistance at the starting point of moving) is referred to as “flow resistance” and described in detail. The flow resistance is also considered to contribute to the binding force.

Therefore, in plural kinds of particle groups 34 which are dispersed in the dispersion medium 50 of the image display medium 12 and have different colors, the threshold for the electric field intensity at which the particles initiate moving can be varied between the groups of the particle groups 34 by, as described above, adjusting the force for separation of the particles of the particle groups 34 (electrostatic force—binding force). For this purpose, the average charge, the flow resistance to the dispersion medium on the particle surface, the average quantity of magnetism (intensity of magnetization), the particle size, and the shape factor of the particles are adjusted alone or in combination thereof for each group of the particle groups.

More specifically, the particle groups 34 composed of particle groups having different thresholds for the electric field intensity to initiate moving can be prepared by varying one or plural factors selected from the average charge, the flow resistance to the dispersion medium on the particles surface, the average quantity of magnetism (intensity of magnetization), the particle size, and the shape factor of the particles between the particle groups, and equating the remaining factors between them.

As the particle groups 34 move in the dispersion medium 50, if the viscosity of the dispersion medium 50 is larger than the predetermined value, the adhesion force to the rear substrate 22 and the display substrate 20 significantly varies, and the threshold of the electric field to initiate the moving of the particles cannot be determined. Therefore, it is necessary to adjust the viscosity of the dispersion medium 50.

The average charge of the particles composing each particle group of the particle groups 34 (magenta particle group 34M, cyan particle group 34C, and yellow particle group 34Y) can be adjusted, specifically, by appropriately controlling the kind and amount of the charge controlling agent added to the above-described resin, the kind and amount of the polymer chain to be combined with the particle surface, the kind and amount of the external additive to be added to or embedded in the particle surface, the kind and amount of the surfactant, polymer chain, and coupling agent added to the particle surface, the specific surface area of the particles (volume average primary particle size and particle shape factor) and other factors.

The binding force and the force for separation can be adjusted by adjusting the average surface roughness of the surface layer 42 and the surface layer 48 of the display substrate 20 and the rear substrate 22, respectively.

The flow resistance of the particles surface to the dispersion medium can be adjusted, specifically, by appropriately adjusting the frequency given by the display substrate 20 and the rear substrate 22 to vibrate the particles on or in the vicinity of the display substrate 20 and the rear substrate 22.

The average quantity of magnetism of the particles can be adjusted, specifically, by various methods to impart magnetism to particles.

For example, particles such as the conventional electrophotographic magnetic toner is prepared by mixing a magnetic body such as powder magnetite with a resin, or by dispersing a magnetic body together with a monomer, and polymerizing. Alternatively, a magnetic body is deposited in the fine pores of porous particles. Methods to coat a magnetic body are also known. For example, polymerization is initiated from the active point provided on the surface of a magnetic body to obtain particles in which the magnetic body is coated with a resin, or a dissolved resin is deposited on the surface of a magnetic body to obtain particles in which a magnetic body is coated with a resin. As the magnetic body, a transparent or colored light-weight organic magnetic body can be used. The average quantity of magnetism of the particles can be adjusted by appropriately adjusting the kind and amount of the magnetic body to be used.

The particle size is, specifically, adjusted when the particles are prepared. When the particles are prepared by polymerization, the particle size can be adjusted by appropriately adjusting the amount of the dispersant, dispersion conditions, heating conditions, and when the particles are prepared by mixing, grinding, and classifying, the particle size can be adjusted by appropriately adjusting the classification conditions or the like. When the constituents of the particles are prepared by milling with a ball mill, the size of steel balls used in the ball mill, the rotating time, the rotating speed and other conditions are appropriately adjusted. The method for the adjustment is not limited to those described above.

The shape factor of the particles is, specifically, for example, preferably adjusted by a method as described in JP-A No. 10-10775, wherein so-called suspension polymerization, in which a polymer is dissolved in a solvent, mixed with a colorant, and dispersed in an aqueous medium in the presence of an inorganic dispersant to obtain particles, is carried as follows: a monomer is added to a non-polymerizable organic solvent which is compatible with the monomer (not or slightly compatible with the solvent), and suspension-polymerized to obtain particles, and the particles are taken out and dried to remove the organic solvent. The drying method is preferably freeze drying, and the freeze drying is preferably carried out in a range of −10 to −200° C. (more preferably −30° C. to −180° C.). The freeze drying is carried out under a pressure of about 40 Pa or less, most preferably 13 Pa or less. The particle shape can be also controlled by the method as described in JP-A No. 2000-292971, wherein small particles are aggregated, unified, and enlarged to a desired particle size.

The average surface roughness of the surface layer 42 and the surface layer 48 of the display substrate 20 and the rear substrate 22 is adjusted by a mechanical method or a chemical method. Examples of the mechanical method include sandblasting, embossing, tooling, die stripping, and die transferring. Examples of the chemical method include light radiation, and drying with a combination of solvents having different drying speeds. The surface roughness of the substrate surface can be adjusted, for example, by applying a resin in which mixed particles of fluorine-based resins, polyamides or the like are dispersed. The average surface roughness can be appropriately adjusted by the methods as described above.

The viscosity of the dispersion medium 50 is essential to be 0.1 mPa·s to 20 mPa·s at a temperature of 20° C. from the viewpoints of the moving velocity of the particles, or the display speed, and preferably 0.1 mPa·s to 5 mPa·s, more preferably 0.1 mPa·s to 2 mPa·s.

When the viscosity of the dispersion medium 50 is in the range of 0.1 mPa·s to 20 mPa·s, the variation in the adhesion force between the particle groups 34 dispersed in the dispersion medium 50 and the display substrate 20 or the rear substrate 22, the flow resistance, and the electrophoresis time can be reduced.

The viscosity of the dispersion medium 50 can be adjusted by appropriately adjusting the molecular weight, structure, composition, and the like of the dispersion medium. The viscosity can be measured with a viscometer (trade name: B-8L, manufactured by Tokyo Keiki Co., Ltd.).

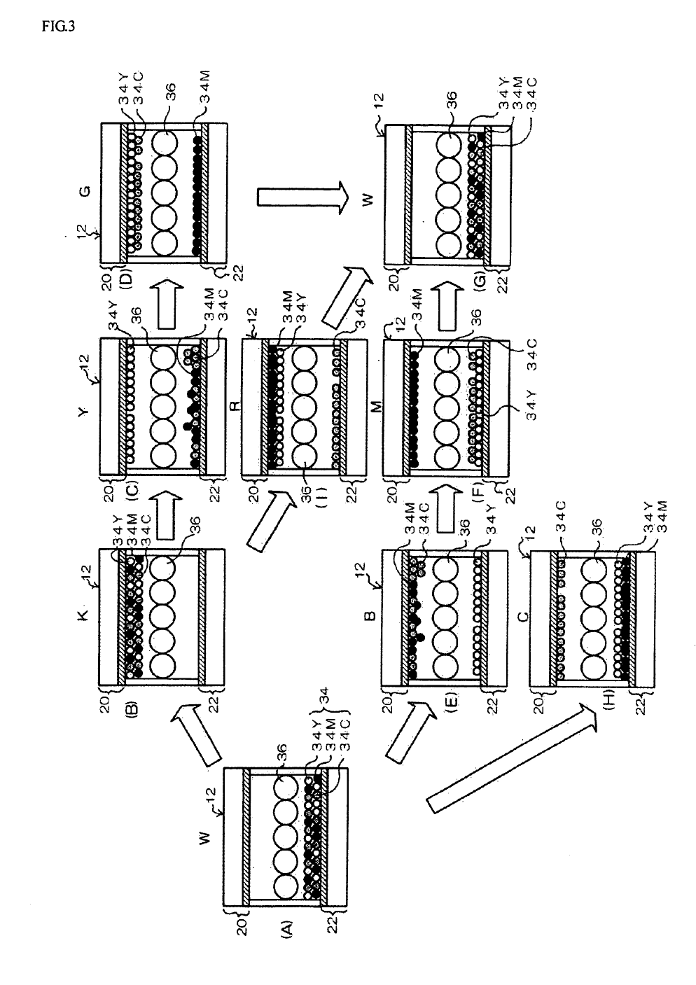

The next section describes the mechanism of the particle movement when an image is displayed on the image display medium 12 of the invention, with reference to FIG. 3.

For example, as the plurality of kinds of particle groups which initiate moving at different intensities of electric field, as shown in FIG. 2, it is supposed that the yellow particle group 34Y as the particle group having the highest threshold, the magenta particle group 34M as the particle group having the second highest threshold following the yellow particle group 34Y, and the cyan particle group 34C as the particle group having the lowest threshold are enclosed in the image display medium 12.

In this instance, the threshold of the electric field intensity which initiates the moving of the yellow particle group 34Y is referred to as “large electric field”, the threshold of the electric field intensity which initiates the moving of the magenta particle group 34M is referred to as “medium electric field”, and the threshold of the electric field intensity which initiates the moving of the cyan particle group 34C is referred to as “small electric field”.

When a higher voltage is applied to the display substrate 20 than that applied to the rear substrate 22 to provide a potential difference, each threshold is referred to as “+large electric field”, “+medium electric field”, and “+small electric field”. When a higher voltage is applied to the rear substrate 22 than that applied to the display substrate 20 to provide a potential difference, each threshold is referred to as “−large electric field”, −medium electric field”, and “−small electric field”.

As shown in FIG. 3(A), if the assumption is made that all the magenta particle group 34M, the cyan particle group 34C, and the yellow particle group 34Y are disposed on the side of the rear substrate 22 in the initial state, when a “+large electric field” is formed between the display substrate 20 and the rear substrate 22, the magenta particle group 34M, the cyan particle group 34C, and the yellow particle group 34Y move to the display substrate 20. In such a state, even if the electric field is put to zero, each particle group of the particle groups does not move from the display substrate 20, and a black color remains displayed by the subtractive color mixture of the magenta particle group 34M, the cyan particle group 34C, and the yellow particle group 34Y (subtractive color mixture of magenta, cyan, and yellow colors) (see FIG. 3(B)).

In the state as shown in FIG. 3(B), if a “−medium electric field” is formed between the display substrate 20 and the rear substrate 22, of all the particle groups 34, the magenta particle group 34M which has the second highest threshold following the yellow particle group 34Y, and the cyan particle group 34C which has the lowest threshold in the particle groups 34 move to the rear substrate 22. Accordingly, only the yellow particle group 34Y remains on the display substrate 20, thus a yellow color is displayed (see FIG. 3(C)).

Furthermore, in the state as shown in FIG. 3(C), if a “+small electric field” is formed between the display substrate 20 and the rear substrate 22, within the magenta particle group 34M and the cyan particle group 34C which moved to the rear substrate 22, the cyan particle group 34C which has a threshold for the small electric field moves from the rear substrate 22 to the display substrate 20. Accordingly, the yellow particle group 34Y and the cyan particle group 34C attach to the display substrate 20, thus a green color due to the subtractive color mixture of yellow and cyan is displayed (see FIG. 3(D)).

In the state as shown in FIG. 3(B), if a “−small electric field” is formed between the display substrate 20 and the rear substrate 22, of all the particle groups 34, the cyan particle group 34C which has the lowest threshold of the particle groups 34 moves to the rear substrate 22. Accordingly, the yellow particle group 34Y and the magenta particle group 34M remain on the display substrate 20, thus a red color due to the additive color mixture of cyan and magenta is displayed (see FIG. 3(I)).

On the other hand, in the initial state as shown in FIG. 3(A), if a “+medium electric field” is formed between the display substrate 20 and the rear substrate 22, of all the particle groups (the magenta particle group 34M, the cyan particle group 34C, and the yellow particle group 34Y), the magenta particle group 34M and the cyan particle group 34C move to the display substrate 20, except for the yellow particle group 34Y which has the highest threshold. Accordingly, the magenta particle group 34M and the cyan particle group 34C attach to the display substrate 20, thus a blue color due to the subtractive color mixture of magenta and cyan is displayed (see FIG. 3(E)).

In the state as shown in FIG. 3(E), if a “−small electric field” is formed between the display substrate 20 and the rear substrate 22, within the magenta particle group 34M and the cyan particle group 34C which attatch to the display substrate 20, the cyan particle group 34C which has a threshold for the small electric field move from the display substrate 20 to the rear substrate 22. Accordingly, only the magenta particle groups 34M remains on the display substrate 20, thus a magenta color is displayed (see FIG. 3(F)).

In the state as shown in FIG. 3(F), if a “−large electric field” is formed between the display substrate 20 and the rear substrate 22, the magenta particle group 34M moves from the display substrate 20 to the rear substrate 22. Accordingly, no particle remain on the display substrate 20, thus a white color of the insulating particles 36 is displayed (see FIG. 3(G)).

In the initial state as shown in the FIG. 3(A), if a “+small electric field” is formed between the display substrate 20 and the rear substrate 22, the cyan particle group 34C which has the lowest threshold of all the particle groups 34 (the magenta particle group 34M, the cyan particle group 34C, and the yellow particle group 34Y) move to the display substrate 20. Accordingly, the cyan particle group 34C attaches to the display substrate 20, thus a cyan color is displayed (see FIG. 3(H)).

Furthermore, in the state as shown in the FIG. 3(I), if a—large electric field is formed between the display substrate 20 and the rear substrate 22, all the particle groups 34 move to the rear substrate 22 as shown in FIG. 3(G), thus a white color is displayed.

In the same manner, in the state as shown in the FIG. 3(D), if a −large electric field is formed between the display substrate 20 and the rear substrate 22, all the particle groups 34 move to the rear substrate 22 as shown in FIG. 3(G), thus a white color is displayed.

As described above, in the image display medium 12 of the invention, plural kinds of particle groups 34, which have different forces for separation from the display substrate 20 and the rear substrate 22, or initiate moving at different electric field intensities, are enclosed in the dispersion medium 50 between the display substrate 20 and the rear substrate 22, and an electric field of the threshold according to each particle group of the particles groups 34 to selectively move desired particles. Therefore, the particles other than the desired color particles are prevented from moving in the dispersion medium 50, and the mixing of undesirable colors is reduced, which can inhibit the deterioration of the image quality of the image display medium 12.

Moreover, as shown in FIG. 3, by dispersing the particle groups 34 composed of cyan, magenta, and yellow in the dispersion medium 50, cyan, magenta, yellow, blue, red, green, and black colors can be displayed, and a white color can be displayed by the insulating particles 36. Thus desired colors can be displayed.

The image display medium of the invention comprises a pair of substrates at least one of which having translucency, the substrates being disposed opposite to each other with a gap, a dispersion medium which has translucency and is enclosed between the pair of substrates and plural kinds of particle groups which are movably dispersed in the dispersion medium, move according to an electric field formed between the substrates, and have different colors and different forces for separation from the substrates.

At least one of the pair of substrates of the image display medium of the invention has translucency, and the substrates are disposed opposite to each other with a gap. A dispersion medium having at least translucency is enclosed in the space between the pair of substrates, and plural kinds of particle groups are dispersed in the dispersion medium.

The plural kinds of particle groups are different each other at least in color, and in the force for separation from the pair of substrates.

Wherein the force of the particle groups to initiate moving from the substrate shows the difficulty in the detachment of the particles of the particle groups from the substrate. The force for separation of the particle groups to initiate moving from the substrate is the difference between the electrostatic force which operates on the particle groups to move the particles from one substrate to the opposing other substrate, and the binding force which opposes the electrostatic force to keep the particle groups at the substrate. More specifically, when the electrostatic force is higher than the binding force, the force for separation to initiate moving from the substrate is positive, and the particles separate from the substrate to move to the opposing other substrate. On the other hand, when the electrostatic force is smaller than the binding force, the force for separation to initiate moving from the substrate is negative, and the particles remain on the original substrate. The difference in the force of the particle groups to separate the substrate indicates that, in consideration of the fact that the particle groups move according to the electric field formed between the pair of substrates, the particle groups initiate moving at different electric field intensities in the dispersion medium.

Thus, the particles of the above-described particle groups initiate moving from one of the pair of substrates to the other substrate at different electric field intensities.

As described above, plural kinds of particle groups dispersed in the dispersion medium between the pair of substrates of the image display medium of the invention have different threshold characteristics for the electric field intensity.

The threshold of the color particle groups for the electric field intensity can be varied by varying the force for separation of each color particle group from the substrate (force for separation=electrostatic force−binding force). This is achieved by generally equating the binding force of the color particle groups, and varying the electrostatic force of the particle groups with the color. Alternatively, it can be also achieved by generally equating the electrostatic force of the color particle groups, and vary the binding force of the particle groups with the color. The force to bind the particle groups on the substrate is a magnetic force, a flow resistance due to the loose network between particles, or a van der Waals force between the particles or between the particles and the substrate. The electrostatic force of the color particle groups can be varied by varying the average charge per particle. In order to generally equate the binding force of the color particle groups and vary the electrostatic force of the particle groups with the color, the magnetic force, the flow resistance of the particles, and the van der Waals force between the particles or between the particles and the substrate are generally equated and the average charge per particle is varied between the particle groups. In order to generally equate the electrostatic force of the color particle groups and vary the binding force of the color particle groups, the average charge per particle is generally equated and the resistance at the interface between the particles of plural kinds of particle groups and the dispersion medium is varied with the kind, the quantity of magnetism per particle is varied with the kind, the volume average primary particle size per particle is varied with the kind, or the shape factor SF1 per particle is varied with the kind.

By adjusting at least one or plural these factors, the color particle groups which are enclosed between the pair of substrates of the image display medium of the invention can have different thresholds for an electric field intensity, and different forces for separation from each of the pair of the substrates.

As described above, plural kinds of particle groups having different colors and forces for separation from the pair of substrates are dispersed in the dispersion medium of image display medium of the invention, thus the formation of electric fields having different intensities between the pair of substrates allows to selectively move the particle group of desired color, which reduces color mixing, and achieves sharp color display with reducing the deterioration of the image quality.

The above-described particle groups may be composed of a cyan particle group of cyan color (C), a magenta particle group of magenta color (M), and a yellow particle group of yellow color (Y). Alternatively, the particle groups may be composed of a red particle group of red color (R), a green particle group of green color (G), and a blue particle group of blue color (B). Thus, color display is achieved in the image display medium.

Moreover, as the particle groups, particle groups whose color forming properties in dispersed state vary with kind may be used.

In the image display medium of the invention, another insulating particles having a color different from that of the above-described particle groups may be enclosed between the pair of substrates to dispose the insulating particles in the direction generally normal to the opposing direction of the pair of substrates with a gap which the particles of the particle groups can pass through.

As aforementioned, insulating particles having a color different from that of each particle group of the plurality of kinds of particle groups enclosed in the space between the pair of substrates are disposed in the direction generally normal to the opposing direction of the pair of substrates with a gap which the particles of the particle groups can pass through, thus the insulating particles allows to exhibit a color different from that of the plurality of kinds of particle groups having different colors.

The image display device of the invention comprises an image display medium and an electric field generating unit between the pair of substrates, which generates an electric field of appropriate intensity according to the particle groups to be moved.

The electric field generating unit generates an electric field of appropriate intensity according to the threshold of each color particle group for the electric field intensity, which allow to selectively move the particle groups of desired color. Accordingly, sharp color display is achieved with reducing the deterioration of the image quality.

### EXAMPLES

### First Exemplary Embodiment

Next, the image display device of the invention in the first exemplary embodiment is described.

The present exemplary embodiment describes the preparation of the image display medium 12 in which the yellow particle group 34Y, the magenta particle group 34M, and the cyan particle group 34C have different average charges from each other but the same magnetic force (magnetism), so as to adjust the color particles of the particle group 34 to give the same adhesion force for the display substrate 20 and the rear substrate 22 for each color, but different electrostatic forces are exerted on the particles for each color.

As shown in FIG. 1, the image display device 10 according to the exemplary embodiment of the invention comprises the image display medium 12, the voltage applying unit 16, and the control unit 18. The control unit 18 is connected to the voltage applying unit 16 in such a manner it can receive signals.

The image display medium 12 corresponds to the image display medium of the invention, the image display device 10 corresponds to the image display device of the invention, and the voltage applying unit 16 corresponds to the voltage applying unit of the image display device of the invention.

The voltage applying unit 16 is electrically connected to the surface electrode 40 and the rear electrode 46. In the present exemplary embodiment, both the surface electrode 40 and the rear electrode 46 are electrically connected to the voltage applying unit 16. One of the surface electrode 40 and the rear electrode 46 may be grounded, and the other may be connected to the voltage applying unit 16.

In the present example, the image display medium 12 uses a transparent conductive ITO supporting substrate of 70 mm×50 mm×1.1 mm as the supporting substrate 38, and plural linear surface electrodes 40 having a width of 0.234 mm are formed on the supporting substrate 38 by etching with spacings of 0.02 mm. In the same manner, an ITO supporting substrate of 70 mm×50 mm×1.1 mm is used as the supporting substrate 44, and plural linear rear electrodes 46 having a width of 0.234 mm are formed on the supporting substrate 44 by etching with spacings of 0.02 mm.

A polycarbonate resin is applied to the opposing surfaces of the display substrate 20 and the rear substrate 22 in a thickness of about 0.5 μm to form the surface layer 42 and the surface layer 48, respectively.

The average surface roughness of the surface layer 42 and the surface layer 48 is measured with a laser displacement microscope (trade name: OLS 1100, manufactured by Olympus Corporation), and found to be Ra 0.2 μm.

The gap member 24 is provided between the display substrate 20 and the rear substrate 22, and formed to a height of 100 μm. The gap member 24 is formed in such a manner to provide cells (a region enclosed by gap members 24, the display substrate 20, and the rear substrate 22) which correspond to respective pixels of an image displayed on the image display medium 12.

The gap member 24 is formed in the desired pattern form on the rear substrate 22 by photolithography using a photoresist film. The cell pattern formed by the gap member 24 is a square cell of 0.254 mm by 0.254 mm generally corresponding to a pixel. The gap member 24 may be also be formed by applying a heat-curing epoxy resin in a desired pattern form to the rear substrate 22 by screen printing, and heat-curing the resin. The process may be repeated until a necessary thickness is achieved. Alternatively, the gap member 24 may be formed by attaching to the rear substrate 22 a thermoplastic film, which has been formed in a desired surface form by injection compression molding, embossing, or hot pressing. The gap member 24 can be integrally formed with the rear substrate 22 by embossing or hot pressing. Of course, the gap member 24 may be formed on the display substrate 20, or integrally formed with the display substrate 20, as long as the transparency is not impaired.

As the plural kinds of particle groups 34 which are enclosed in the cell of the image display medium 12 of the invention, in the present exemplary embodiment, a magenta particle group 34M of magenta color, a cyan particle group 34C of cyan color, and a yellow particle group 34Y of yellow color are enclosed, as shown in FIG. 1.

The magenta particles of the magenta particle group 34M of magenta color are prepared by the following procedure.

53 parts by weight of cyclohexyl methacrylate, 3 parts by weight of a magenta pigment (trade name: Carmine 6B, manufactured by Dainichiseika Color & Chemicals Manufacturing Co., Ltd.), 2 parts by weight of a charge controlling agent (trade name: COPY CHARGE PSY VP2038, manufactured by Clariant in Japan), and 13.3 parts by weight of magenta color-coated magnetite are ground in a ball mill for 20 hours together with zirconia balls having a diameter of 10 mm to obtain a dispersion liquid A. 40 parts by weight of calcium carbonate and 60 parts by weight of water are finely ground in a ball mill to obtain a calcium carbonate dispersion liquid B. 4.3 g of 2% Cellogen (trade name) aqueous solution, 8.5 g of the calcium carbonate dispersion liquid, and 50 g of 20% salt water are mixed, the mixture is deaerated in an ultrasonic device for 10 minutes, and stirred in an emulsifier to obtain a mixed solution C. Thorough mixing of 35 g of the dispersion liquid A and 1 g of divinylbenzene, and 0.35 g of a polymerization initiator AIBN is carried out, and the mixture is deaerated in an ultrasonic device for 10 minutes. The mixture is added to the mixed solution C, and emulsified with an emulsifier.

Subsequently, the emulsified liquid is put in a bottle, closed with a silicon cap, and pressure is reduced by thoroughly removing air using an injection needle. The bottle is filled with nitrogen gas, followed by reacting at 60° C. for 10 hours to obtain particles. The obtained particle powder is dispersed in ion-exchanged water, calcium carbonate is decomposed with hydrochloric acid water, and the mixture is filtered. Subsequently, the particles are thoroughly washed with distilled water, sorted by particle size, and dried. 2 parts by weight of the obtained particles are put in 98 parts by weight silicone oil (octamethyl trisiloxane) together with 2 parts by weight of a nonionic surfactant polyoxyethylene alkylether, stirred, and dispersed to obtain a mixed solution.

In the present exemplary embodiment, as described above, the particles of the magenta particle group 34M by containing magenta color-coated magnetite as a magnetic material a magnetic force can be imparted to the particles. The thus obtained magenta particles have a volume average primary particle size of 1 μm, and display a negative charge.

As the cyan particle group 34C of cyan color, cyan particles are prepared by the following procedure. The cyan particles are prepared in the same manner with the magenta particles, except that the magenta pigment is replaced with a cyan pigment (trade name: Cyanine Blue 4933M, manufactured by Dainichiseika Color & Chemicals Manufacturing.Co.,Ltd.), magenta color-coated magnetite is replaced with cyan color-coated magnetite, and the amount of the charge controlling agent (trade name: COPY CHARGE PSY VP 2038, manufactured by Clariant in Japan) is increased to 3 parts by weight.

In the present exemplary embodiment, as described above, the particles of the cyan particle group 34C may contain cyan color-coated magnetite as a magnetic material to impart a magnetic force to the particles.

The thus obtained cyan particles have a volume average primary particle size of 1 μm.

As the yellow particle group 34Y of yellow color, are prepared by the following procedure. The yellow particles are prepared in the same manner with the magenta particles, except that the magenta pigment is replaced with a yellow pigment (trade name: Pigment Yellow 17, manufactured by Dainichiseika Color & Chemicals Manufacturing.Co.,Ltd.), magenta color-coated magnetite is replaced with yellow color-coated magnetite, and the amount of the charge controlling agent (trade name: COPY CHARGE PSY VP 2038, manufactured by Clariant in Japan) is decreased to 1 parts by weight.

In the present exemplary embodiment, as described above, the particles of the yellow particle group 34Y may contain yellow color-coated magnetite as a magnetic material to impart a magnetic force to the particles.

The thus obtained yellow particles have a volume average primary particle size of 1 μm.

The volume average primary particle size is, when the particles to be measured have a diameter of 2 μm or more, measured with a Coulter Counter TA-II (manufactured by Beckman Coulter), and an electrolyte (trade name: ISOTON-II, manufactured by Beckman Coulter).

The measuring method is as follows. 0.5 to 50 mg of the sample for measurement is added to 2 ml of a surfactant as a dispersant, preferably 5% aqueous solution of sodium alkylbenzene sulfonate, and the mixture is added to 100 to 150 ml of the electrolyte. The suspension of the sample in the electrolyte is dispersed in an ultrasonic disperser for about 1 minutes, and the particle size distribution of the particles having a particle size of 2.0 to 60 μm is measured with the Coulter Counter TA-IL using an aperture having an aperture diameter of 100 μm. The number of the particles for measurement is 50,000.

With the thus measured particle size distribution, for the divided particle size range (channel), a cumulative distribution is drawn for each of volume and number from the side of small diameter, and the particle size at the point where the accumulation by volume reaches 16% is defined as the volume average particle size D16v, and the cumulative number particle size at the point where the accumulation by number reaches 16% is defined as D16p. In the same manner, the particle size at the point where the accumulation by volume reaches 50% is defined as the volume average particle size D50v, and the particle size at the point where the accumulation reaches 50% is defined as the number average particle size D50p. Furthermore, in the same manner, the particle size at the point where the accumulation by volume reaches 84% is defined as the volume average particle size D84v, and the cumulative number particle size at the point where the accumulation by number reaches 84% is defined as D84p. The volume average primary particle size is D50v.

Using these values, the volume average particle size distribution index (GSDv) is calculated by (D84v/D16v)^{1/2}, the number average particle size index (GSDp) is calculated by (D84p/D16p)^{1/2}, and the small diameter particle number average particle size (lower GSDp) is calculated by {(D50p)/(D16p)}.

On the other hand, when the diameter of the particles to be measured is less than 2 μm, the particles are measured with a laser diffraction particle size distribution meter (trade name: LA-700, manufactured by Horiba, Ltd.). The measuring method is as follows. The sample in a dispersion liquid state is adjusted to have a solids content of about 2 g, to the solution ion-exchanged water is added to make about 40 Ml. The mixture is put in a cell to an adequate concentration, and after a lapse of about two minutes, measurement is carried out when the concentration in the cell is almost stabilized. The thus obtained volume average primary particle size of each channel is accumulated from the smaller volume average primary particle size, and the point at which the accumulation reaches 50% is determined as the volume average primary particle size.

When fine particles such as an external additive is measured, 2 g of the sample for measurement is added to 50 ml of a surfactant, preferably 5% aqueous solution of sodium alkylbenzene sulfonate, and the mixture is dispersed in an ultrasonic disperser (1,000 Hz) for two minutes to obtain the sample. The sample is measured in the same manner as the above-described dispersion liquid.

As the insulating particles 36, the particles prepared as follows are used.

53 parts by weight of cyclohexyl methacrylate, 45 parts by weight of titanium oxide (trade name: Tipaque CR63, manufactured by Ishihara Sangyo Kaisha, Ltd.), and 5 parts by weight of cyclohexane are ground for 20 hours in a ball mill together with zirconia balls having a diameter of 10 mm to obtain a dispersion liquid A. 40 parts by weight of calcium carbonate and 60 parts by weight of water are finely ground in a ball mill to obtain a carcium carbonate dispersion liquid B. 4.3 g of 2% Cellogen aqueous solution, 8.5 g of calcium carbonate dispersion liquid, and 50 g of 20% salt water are mixed, the mixture is deaerated in an ultrasonic device for 10 minutes, and stirred in an emulsifier to obtain a mixed solution C. 35 g of the dispersion liquid A and 1 g of divinylbenzene, and 0.35 g of a polymerization initiator AIBN are thoroughly mixed, and the mixture is deaerated in an ultrasonic device for 10 minutes. The mixture is added to the mixed solution C, and emulsified with an emulsifier.

Subsequently, the emulsified liquid is put in a bottle, closed with a silicon cap, and thoroughly deaerated under reduced pressure using an injection needle. The bottle is filled with a nitrogen gas, followed by reacting at 60° C. for 10 hours to obtain particles. After cooling, the dispersion liquid is subjected to freeze drying at −35° C., 0.1 Pa for two days to remove cyclohexane. The thus obtained fine particles are dispersed in ion-exchanged water, calcium carbonate is decomposed with hydrochloric acid water, and the mixture is filtered. Subsequently, the particles are thoroughly washed with distilled water, uniformed in the particle size, and dried. The insulating particles 36 have a white color, and a volume average primary particle size of 20 μm. The volume average primary particle size is measured by the above-described procedure.

The yellow particle group 34Y, the magenta particle group 34M, and the cyan particle group 34C prepared as above are separately dispersed in silicone oil having a viscosity of 1 cs (manufactured by Shin-Etsu Chemical Co., Ltd.) at a concentration of 2 parts by weight. The dispersion liquids of the particles groups are mixed in a volume ratio of 1:1:1, and the dispersion liquid of the mixed particles is filled on the rear substrate 22, on which the gap member 24 has been formed, to fill each cell with the dispersion liquid of the mixed particles.

The insulating particles 36 are mixed with the dispersion medium 50 in the proportion of 1 to 100, such that the particles are disposed along the opposing direction of the display substrate 20 and the rear substrate 22 with a gap which the particles of the particle groups 34 can pass through, and provided in the cell in such a manner that the distances between the insulating particles 36 and the display substrate 20, and between the insulating particles 36 and the rear substrate 22 are nearly equal.

The image display medium 12 of the invention can be prepared as follows. On the rear substrate 22, on which the gap member 24 has been provided, the mixture of the plurality of kinds of particle groups 34, the insulating particle 36, and the dispersion medium is put in each cell as described above, then the display substrate 20 is disposed, and the rear substrate 22 and the display substrate 20 are fixed with a clamp or the like.

The average charge of the yellow particle group 34Y which has been enclosed in each cell as described above is −7.0×10¹⁷ C per particle.

The average charge of the magenta particle group 34M is −10.5×10⁻¹⁷ C per particle. The average charge of the cyan particle group 34C is −14.0×10⁻¹⁷ C per particle.

The average charge can be determined, for example, by measuring the electrophoresis electric current of a specified weight of particles. A dispersion liquid in which a specified weight of particles is dispersed is filled in a parallel plate electrode cell, a voltage is applied between the parallel plate electrodes, and the electric current when all the filled particles move between the electrodes is measured to calculate the electric charge. The electric charge per particle is calculated from the electric charge and the particle weight. The calculation is carried out on the assumption that the particles are truly spherical and have a uniform diameter.

The shape factor the yellow particle group 34Y, the magenta particle group 34M, and the cyan particle group 34C is measured and found to be 107, 107, and 106, respectively, which are generally equivalent.

The shape factor is, as described in JP-A No. 2003-57688, a factor showing the characteristic of the particle shape defined by a formula: shape factor=(L²/S)/4π×100. The shape factor can be determined as follows: particles are observed under a scanning electron microscope (SEM), the photomicrograph is analyzed with an image analyzer (trade name: Luzex, manufactured by Nireco Corporation) to determine the area (S) and perimeter (L) of a particle, and the particle shape is quantified by the above formula.

The total volume ratio of the particle groups 34 to the void volume between the substrates (corresponding to the cell volume) is about 3%. The total volume ratio of the insulating particles 36 to the void volume between the substrates is about 10%.

Electric fields each having an intensity of 5×10⁵ V/m, 7.5×10⁵ V/m, and 10×10⁵ V/m are formed between the display substrate 20 and the rear substrate 22 of the image display medium 12, wherein the yellow particle group 34Y, the magenta particle group 34M, and the cyan particle group 34C which have different average charges and a magnetic force (magnetism) are enclosed; the electrostatic force (N) (electrostatic force by electric field E, F=q.E) exerted on the particles by the electric field is shown in Table 1.

TABLE 1

| | | Electric field intensity (V/m) | | |
|---|---|---|---|---|
| | Charge (C/particle) | 5 × 10⁵ | 7.5 × 10⁵ | 10 × 10⁵ |
| Yellow color particles | −7.0 × 10⁻¹⁷ | 3.5 × 10⁻¹¹ | 5.3 × 10⁻¹¹ | 7.0 × 10⁻¹¹ |
| Magenta color particles | −10.5 × 10⁻¹⁷ | 5.3 × 10⁻¹¹ | 7.9 × 10⁻¹¹ | 10.5 × 10⁻¹¹ |
| Cyan color particles | −14.0 × 10⁻¹⁷ | 7.0 × 10⁻¹¹ | 10.5 × 10⁻¹¹ | 14.0 × 10⁻¹¹ |

On the assumption that the particles initiates moving from one substrate to the opposing substrate only when an electrostatic force higher than the binding force is exerted on the particles, when a binding force (wherein mainly magnetic force) of less than 7.0×10⁻¹¹ N which binds the particles to one substrate is exerted on the particles, the cyan particle group 34C which has an electrostatic force of 7.0×10⁻¹¹ N or more for an electric field intensity of 5×10⁵ V/m, the magenta particle group 34M which has an electrostatic force of 7.0×10⁻¹¹ or more for an electric field intensity of 7.5×10⁵ V/m and the cyan particle group 34C, and the yellow particle group 34Y which has an electrostatic force of 7.0×10⁻¹¹ N or more for an electric field intensity of 10×10⁵ V/m, the magenta particle group 34M, and the cyan particle group 34C move.

From the above fact, in the present exemplary embodiment, the magnetic force is defined as 6.5×10⁻¹¹ N. It can be adjusted by the magnetic characteristics of the particles and by providing a magnet on the display substrate 20 and the rear substrate 22.

Accordingly, desired colors can be displayed by defining a threshold at which only a specific color particle of the particle groups 34 initiates moving, and selectively moving the color particles of the particle groups 34 as illustrated in FIG. 3.

Moreover, as the present exemplary embodiment, in order to adjust the particles of the particle groups 34 to have the same magnetic force for the display substrate 20 and the rear substrate 22, and different electrostatic forces, the yellow particle group 34Y, the magenta particle group 34M, and the cyan particle group 34C which have different average charges and the same magnetic force (magnetism) are enclosed in the image display medium 12. Accordingly, the binding force for the display substrate 20 and the rear substrate 22 depends on the nearly equal magnetic forces of the particles.

When the magnetic force as the binding force is the same, and only the average charge is different between the particle groups, the threshold for the electric field intensity can be readily adjusted by adjusting the average charge. The magnetic force is exerted even on the particles which are out of contact with the substrate surface as long as they are accumulated on the substrate surface. Accordingly, the magnetic force enhances the binding ability of the particles to the substrate, which inhibits color mixing caused by the detachment of particles which should not be detached.

In the above example, the charge of the particles groups is adjusted by adjusting the amount of the charge controlling agent contained in the particles of the particles groups. The charge of the particles groups can be also adjusted by known methods such as adding an external additive such as a surfactant, which is used for a liquid developer, to the dispersion liquid of the particles, or changing the resin composition of the particles. Alternatively, the charge can be adjusted also by changing the volume average primary particle size of the particles of the particle groups, or changing the surface irregularities of the particles to vary the specific surface area of the particle groups.

### Second Example

In the first example, in order to adjust the color particle groups of the particle groups 34 to have the same binding force for the display substrate 20 and the rear substrate 22 and different electrostatic forces, the yellow particle group 34Y, the magenta particle group 34M, and the cyan particle group 34C which have different average charges and nearly equal magnetic forces (magnetism) are enclosed in the image display medium 12. In the present exemplary embodiment, the particles groups are adjusted to have different average charges and nearly equal flow resistances to the dispersion medium 50.

The present exemplary embodiment has generally the same configuration with the image display medium 12 in the above-described first exemplary embodiment. Therefore, the same elements are generally indicated by the same reference numerals, the detailed explanation thereof is omitted, and only different elements are described.

In the present exemplary embodiment, the color particle groups accumulated on the rear substrate form a loose network in the particle dispersion liquid, which increases the viscosity around the particles. Then a voltage of a frequency to vibrate particles is applied to break the loose network between the particles to reduce the flow resistance of the particles. As the dispersion medium 50, a particle dispersion liquid composition which has thixotropic properties to cause a flow resistance between the particles of the particle groups 34 is selected. In the present exemplary embodiment, a dispersion medium which has such particle dispersion liquid characteristics (trade name: Norpar15, manufactured by Exxon Corporation) having a viscosity of about 1 mP·s is used as the dispersion medium 50.

The magenta particles of the magenta particle group 34M are prepared by the following procedure. A mixture of 40 parts by weight of a copolymer of ethylene (89%) and methacrylic acid (11%) (trade name: Nucrel N699, manufactured by Du Pont), 8 parts by weight of a magenta pigment (trade name: Carmine 6B, manufactured by Dainichiseika Color & Chemicals Manufacturing.Co.,Ltd.), and 2 parts by weight of a charge controlling agent (trade name: COPY CHARGE PSY VP2038, manufactured by Clariant in Japan) is put in a stainless steel beaker, and heated in an oil bath at 120° C. for 1 hour with stirring to obtain a uniform melt of the completely molten resin, the pigment, and the charge controlling agent. The thus obtained melt is gradually cooled to room temperature with stirring, and 100 parts of Norpar 15 (manufactured by Exxon Corporation) are added. With the decrease in the temperature of the system, mother particles containing the pigment and the charge controlling agent and having a particle size of 10 to 20 μm deposits. 100 g of the deposited mother particles is put in a 01 type attritor, and ground together with steel balls having a diameter of 0.8 mm. The grinding is continued until the particle size becomes 2.5 μm with monitoring the volume average particle size using a centrifugal particle size distribution analyzer (trade name: SA-CP4L, manufactured by Shimadzu Co., Ltd.). 20 parts of the obtained concentrated toner (particle concentration: 18% by weight) is diluted with 160 parts by weight of eicosane (C₂₀H₄₂, melting point: 36.8° C.), which has been previously molten by heating at 75° C., to achieve a particle concentration of 2% by weight with reference to the particle dispersion liquid, and thoroughly stirred.

In the present exemplary embodiment, as described above, a voltage of a frequency to vibrate the particles of the magenta particle group 34M is applied to the particles to adjust the flow resistance of the magenta particles to the dispersion medium 50 used in the present exemplary embodiment to 6×10⁻¹¹ N.

The thus obtained magenta particles have a volume average primary particle size of 1 μm, and a negative charge.

As the cyan particle group 34C, cyan particles are prepared by the following procedure. The cyan particles are prepared in the same manner with the magenta particles, except that the magenta pigment is replaced with a cyan pigment (trade name: Cyanine Blue 4933M, manufactured by Dainichiseika Color & Chemicals Manufacturing.Co.,Ltd.). The thus obtained cyan particles have a volume average primary particle size of 1 μm.

As the yellow particle group 34Y, yellow particles are prepared by the following procedure. The yellow particles are prepared in the same manner with the magenta particles, except that the magenta pigment is replaced with a yellow pigment (trade name: Pigment Yellow 17, manufactured by Dainichiseika Color & Chemicals Manufacturing.Co.,Ltd.).

In the present exemplary embodiment, as described above, a voltage of a frequency to vibrate the particles of the yellow particle group 34Y is applied to the particles to equate the flow resistance to the dispersion medium 50 with that of the magenta particle group 34M.

The thus obtained yellow particles have a volume average primary particle size of 1 μm.

The average charge of the yellow particle group 34Y, the magenta particle group 34M, and the cyan particle groups 34M enclosed in each cell as described above is the same with that in the first exemplary embodiment.

Desired colors can be displayed by defining a threshold to initiate moving for each color particle group of the particle groups 34 prepared in the second example, and selectively moving each color particle group of the particle groups 34 as illustrated in FIG. 3.

As the present exemplary embodiment, when the yellow particle group 34Y, the magenta particle group 34M, and the cyan particle group 34C which have different average charges and nearly equal flow resistances to the liquid are enclosed in the image display medium 12 as the particle groups which initiate moving at different electric field intensities, the binding force for the display substrate 20 and the rear substrate 22 depends on the flow resistance of the particles.

The flow resistance is reduced by applying a frequency to vibrate the particles in the dispersion medium 50 to break the network between the particles accumulated on and in the vicinity of the substrate surface.

When the color particles of particle groups 34 have the same flow resistance and different average charges, the threshold for the electric field intensity can be readily adjusted by adjusting the average charges.

### Third Example

In the first example, in order to adjust the color particle groups of the particle groups 34 to have the same binding force for the display substrate 20 and the rear substrate 22 and different electrostatic forces, the yellow particle group 34Y, the magenta particle group 34M, and the cyan particle group 34C which have different average charges and nearly equal magnetic forces (magnetism) are enclosed in the image display medium 12. In the present exemplary embodiment, the particles groups are adjusted to have different average charges and nearly equal adhesion forces (van der Waals force) to the display substrate 20 and the rear substrate 22.

The present exemplary embodiment has generally the same configuration with the image display medium 12 in the above-described first exemplary embodiment. Therefore, the same elements are generally indicated by the same reference numerals, the detailed explanation thereof is omitted, and only different elements are described.

In the present exemplary embodiment, as the magenta particle group 34M, magenta particles are prepared by the following procedure.

The magenta particles are prepared in the same manner with the procedure for preparing magenta particles as described in Example 1, except that the dispersion liquid A is prepared with a composition excluding magnetite. The thus obtained particles are observed under SEM and found to be spherical. The shape factor is determined as 120. In the present exemplary embodiment, as described above, the surface of the particles of the magenta particle group 34M has a fine irregularity structure so that the adhesion force to the display substrate 20 and the rear substrate 22 is equated with that of the cyan particle group 34C and the yellow particle group 34Y.

As the cyan particle group 34C, cyan particles are prepared by the following procedure. The cyan particles are prepared in the same manner with the procedure for preparing the cyan particles of the cyan particle group 34C as described in Example 1, except that the dispersion liquid A is prepared with a composition excluding magnetite.

In the present exemplary embodiment, as described above, the surface of the particles of the cyan particle group 34C has a fine irregularity structure so that the adhesion force to the display substrate 20 and the rear substrate 22 is equated with that of the above-described magenta particle group 34M.

The shape factor of the thus obtained cyan particles is determined as 120.

As the yellow particle group 34Y, yellow particles are prepared by the following procedure. The yellow particles are prepared in the same manner with the procedure for preparing the yellow particles of the yellow particle group 34Y as described in Example 1, except that the dispersion liquid A is prepared with a composition excluding magnetite.

In the present exemplary embodiment, as described above, the surface of the particles of the yellow particle group 34Y has a fine irregularity structure so that the adhesion force to the display substrate 20 and the rear substrate 22 is equated with that of the above-described magenta particle group 34M and the cyan particle group 34C.

The shape factor of the thus obtained yellow particles is determined as 120.

The shape factor is calculated as follows: the particles are observed under a scanning electron microscope (SEM), and the photomicrograph is analyzed with an image analyzer (trade name: Luzex, manufactured by Nireco Corporation) to determine the area (S) and perimeter (L) of a particle, and the particle shape is calculated.

The average charge of the yellow particle group 34Y, the magenta particle group 34M, and the cyan particle groups 34M enclosed in each cell as described above is the same with that in the first exemplary embodiment.

Desired colors can be displayed by defining a threshold to initiate moving for each color particle group of the particle groups 34 prepared in the third example, and selectively moving each color particle group of the particle groups 34 as illustrated in FIG. 3.

As the present exemplary embodiment, when the particle groups, which initiate moving at different electric field intensities, have different average charges and nearly equal adhesion forces to the display substrate 20 and the rear substrate 22, the particles move to the opposing substrate when an electric field which is higher than the adhesion force and has an intensity higher than the threshold of the particles groups 34 for the electric field intensity is formed. Accordingly, the threshold for the electric field intensity can be readily defined by adjusting the average charge of the particles.

In the present example, the adhesion force of particles to the display substrate 20 and the rear substrate 22 is, at the micro level from the viewpoint of each particle, composed of a van der Waals force between the particles and the substrate, and an interparticle van der Waals. At the macro level from the viewpoint of whole particles, the force is regarded as the adhesion force between the substrate and the particle groups including those out of contact with the substrate.

In the present exemplary embodiment, the van der Waals force is controlled by the shape of the particles. It can be also adjusted by the selection of the material of the particles or the substrate.

### Fourth Example

In the first example, in order to adjust the color particle groups of the particle groups 34 to have the same binding force for the display substrate 20 and the rear substrate 22 and different electrostatic forces, the yellow particle group 34Y, the magenta particle group 34M, and the cyan particle group 34C which have different average charges and nearly equal magnetic forces (magnetism) are enclosed in the image display medium 12. In the present exemplary embodiment, the particles groups are adjusted to have nearly equal average charges and different magnetic forces (quantity of magnetism).

The present exemplary embodiment has generally the same configuration with the image display medium 12 in the above-described first exemplary embodiment. Therefore, the same elements are generally indicated by the same reference numerals, the detailed explanation thereof is omitted, and only different elements are described.

In the present exemplary embodiment, as the magenta particle group 34M, magenta particles are prepared by the following procedure. The magenta particles are prepared in the same manner as the magenta particles of the magenta particle group 34M as described in Example 1.

In the present exemplary embodiment, as described above, the particles of the magenta particle group 34M contain 13.3 parts by weight of magenta color-coated magnetite so that the quantity of magnetism (saturated magnetization σs) of the particles of the magenta particle group 34M is adjusted to 12 emu/g.

As the cyan particle group 34C, cyan particles are prepared by the following procedure. The cyan particles are prepared in the same manner with the procedure for preparing the cyan particles of the cyan particle group 34C as described in Example 1, except that the cyan color-coated magnetite in the dispersion liquid A is decreased to 6.7 parts by weight.

In the present exemplary embodiment, as described above, the particles of the cyan particle group 34C contain 6.7 parts by weight of cyan color-coated magnetite so that the quantity of magnetism (saturated magnetization as) of the particles of the cyan particle group 34C is adjusted to 8 emu/g, which is lower than that of the above-described magenta particle group 34M.

As the yellow particle group 34Y, yellow particles are prepared by the following procedure. The yellow particles are prepared in the same manner with the procedure for preparing the yellow particles of the yellow particle group 34Y as described in Example 1, except that the yellow color-coated magnetite in the dispersion liquid A is increased to 20 parts by weight.

In the present exemplary embodiment, as described above, the particles of the yellow particle group 34Y contain 20 parts by weight of yellow color-coated magnetite so that the quantity of magnetism (saturated magnetization as) of the particles of the yellow particle group 34Y is adjusted to 16 emu/g, which is higher than that of the above-described magenta particle group 34M.

The average charge of the yellow particle group 34Y, the magenta particle group 34M, and the cyan particle groups 34C which are enclosed in each cell is −10.5×10⁻¹⁷ C per particle.

The quantity of magnetism of the particles is measured with a vibrating sample magnetometer (trade name, manufactured by Toei Kogyosha) under a magnetic field of up to 5 kOe.

Desired colors can be displayed by defining a threshold to initiate moving for each color particle group of the particle groups 34 prepared in the fourth example, and selectively moving each color particle group of the particle groups 34 as illustrated in FIG. 3.

The yellow particle group 34Y has the highest magnetic force, the magenta particle group 34M has the second highest magnetic force, and the cyan particle group 34C has the lowest magnetic force, thus the magnetic field intensity required for moving them increases in the order of the yellow particle group 34Y, the magenta particle group 34M, and the cyan particle group 34C. Accordingly, the threshold for the electric field intensity is defined in such a manner that it increases in this order.

As described above, by adjusting the particle groups 34 in such a manner the color particle groups have nearly the same average charge and different magnetic forces (quantity of magnetism), they can be adjusted as the particle groups which initiate moving at different intensities of electric field.

The magnetic force effectively operates even on the particles out of contact with the substrate, which thoroughly prevents the particles which should not move from moving with other moving particles, and inhibits color mixing.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplate. It is intended that the scope of the invention be defined by the following claims and their equivalents.

All publications, patent applications, and technical standards mentioned in this specification are incorporated by reference to the same extent as if each individual publication, patent application, or technical standard was specifically and individually indicated to be incorporated by reference.

What is claimed is:

1. An image display medium comprising:
a pair of substrates at least one of which having translucency, the substrates being disposed opposite to each other with a gap therebetween;
a dispersion medium that has translucency and is enclosed between the pair of substrates; and
a plurality of kinds of particle groups that are movably dispersed in the dispersion medium, move according to an electric field, and different kinds have different colors and different forces for separation from the substrates.

2. The image display medium of claim 1, wherein the particle groups initiate moving from one substrate of the pair of substrates to the other substrate at different electric field intensities.

3. The image display medium of claim 1, wherein the resistance at the interface between the dispersion medium and the particle of the plurality of kinds of particle groups is different for each of the kinds of particle group.

4. The image display medium of claim 1, wherein the average charge of a particle is different between the particle groups of the plurality of kinds of particle groups.

5. The image display medium of claim 1, wherein the magnetic charge of a particle is different between the particle groups of the plurality of kinds of particle groups.

6. The image display medium of claim 1, wherein the volume average primary particle size of a particle is different between the particle groups of the plurality of kinds of particle groups.

7. The image display medium of claim 1, wherein the shape factor SF1 of a particle is different between the particle groups of the plurality of kinds of particle groups.

8. The image display medium of claim 1, wherein the flow resistance to the dispersion medium on the surface of particles is different between the particle groups of the plurality of kinds of particle groups.

9. The image display medium of claim 1, wherein the particle groups are composed of a magenta particle group of magenta color, a yellow particle group of yellow color, and a cyan particle group of cyan color.

10. The image display medium of claim 1, wherein the color forming properties exhibited by the particle groups in a dispersed state are different between the kinds.

11. The image display medium of claim 1, wherein electrically insulating particles having a different color from the particle groups are further enclosed between the pair of substrates, the electrically insulating particles being disposed with gaps between the insulating particles, which the particles of the particle groups can pass through, and disposed in the direction substantially at right angles to the normal to the pair of substrates.

12. The image display medium of claim 1, wherein the dispersion medium is an electrically insulating liquid.

13. The image display medium of claim 1, wherein the viscosity of the dispersion medium is about 0.1 mPa·s to about 20 mPa·s at a temperature of 20° C.

14. An image displaying method for displaying different colors by varying the intensity of electric field between the pair of substrates of the image display medium of claim 1.

15. An image display device comprising:
an image display medium comprising,
a pair of substrates at least one of which having translucency, the substrates being disposed opposite to each other with a gap therebetween,
a dispersion medium that has translucency and is enclosed between the pair of substrates, and
a plurality of kinds of particle groups that are movably dispersed in the dispersion medium, move according to an electric field, and different kinds have different colors and different forces for separation from the substrates; and
an electric field generating unit that forms electric field of appropriate intensity between the pair of substrates according to the particle groups to be moved.
